(19) United States
(12) Patent Application Publication
(10) Pub. No.: US 2018/0093646 A1
(43) Pub. Date: Apr. 5, 2018

(54) WASHING EQUIPMENT FOR A VEHICLE

(71) Applicant: ALSTOM Transport Technologies, Saint-Ouen (FR)

(72) Inventor: Jorge Pereira, Biarritz (FR)

(21) Appl. No.: 15/722,224

(22) Filed: Oct. 2, 2017

(30) Foreign Application Priority Data
Sep. 30, 2016 (FR) 1659426

(51) Int. Cl. B60S 3/04; B60S 3/00; B05B 3/06; B05B 13/06; B05B 7/32

(52) U.S. Cl. CPC B60S 3/048; B60S 3/006; B01F 15/0479; B05B 13/0627; B05B 7/32; B05B 3/066

(57) ABSTRACT

Washing equipment for a vehicle includes at least one gantry defining a track for the vehicle, at least one nozzle supported by the gantry and intended to spray a cleaning liquid on the vehicle, and a helical profile that creates a helical rotational movement of the cleaning liquid relative to the gantry. The helical profile is suitable for ensuring the rotation of the cleaning liquid around the axis of the stream of cleaning liquid leaving the nozzle.

The present invention relates to washing equipment for a vehicle, comprising:
at least one gantry defining a track for the vehicle,
at least one nozzle supported by the gantry and intended to spray a cleaning liquid on the vehicle, and
means able to create a helical rotational movement of the cleaning liquid relative to the gantry.

Such equipment is in particular intended to wash railway vehicles, such as trains or trams, or even buses.

Some washing equipment uses a brushing system to clean the body of the vehicle. However, this type of system is expensive to maintain, due to the moving parts used. Furthermore, the brushes used can destroy the body of the vehicle.

Thus, brushless washing equipment exists that includes a washing system provided with several nozzles spraying a cleaning liquid. These nozzles are arranged on a rotor mounted rotating relative to a gantry. They are off-centered relative to the axis of the rotor such that when the rotor rotates, the nozzles are rotated around a same axis made up of the rotation axis of the rotor. Each stream leaving each nozzle then describes a helix centered on the rotation axis of the rotor. The streams leaving the nozzles are interwoven like the turns of a coil.

However, such a washing system is unreliable and requires frequent maintenance of the moving rotor.

The invention aims to provide a system requiring less maintenance.

To that end, the invention relates to washing equipment of the aforementioned type, wherein the means able to create a helical rotational movement are suitable for ensuring the rotation of the cleaning liquid around the axis of the stream of cleaning liquid leaving the nozzle.

Washing equipment according to the invention can further comprise one or more of the following features, considered alone or in any technically possible combinations:
the means able to create a helical rotational movement are situated in a pipe for passage of the cleaning liquid;
the means able to create a helical rotational movement are situated in the nozzle;
the means able to create a helical rotational movement include a helical profile situated on an inner wall of a passage pipe for the cleaning liquid;
the means able to create a helical rotational movement include several helical profiles distributed over a circumference of the inner wall of the pipe for passage of the cleaning liquid;
the means able to create a helical rotational movement comprise at least one vane;
the gantry supports several nozzles spaced longitudinally apart from one another;
the means able to create a helical rotational movement are arranged so that the rotation direction of the cleaning liquid leaving each nozzle alternates between the adjacent nozzles; and
said washing equipment comprises means for rotating the nozzle around an axis perpendicular to the longitudinal axis of the gantry and off-centered relative to the axis of the nozzle.

The invention also relates to a washing method consisting of setting a cleaning liquid in helical rotation around the axis of the stream of cleaning liquid and spraying it on a vehicle.

Other aspects and advantages of the invention will appear upon reading the following description, provided as an example, and done in reference to the appended drawings, in which:

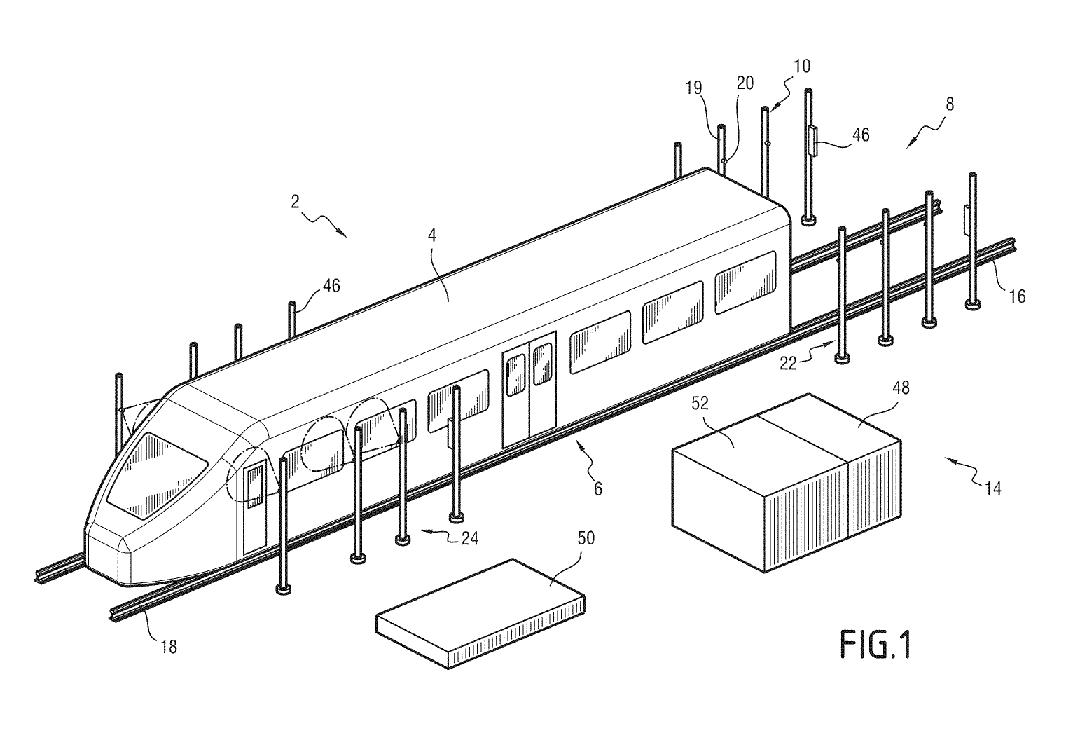

FIG. 1 is a schematic perspective view of washing equipment according to the invention;

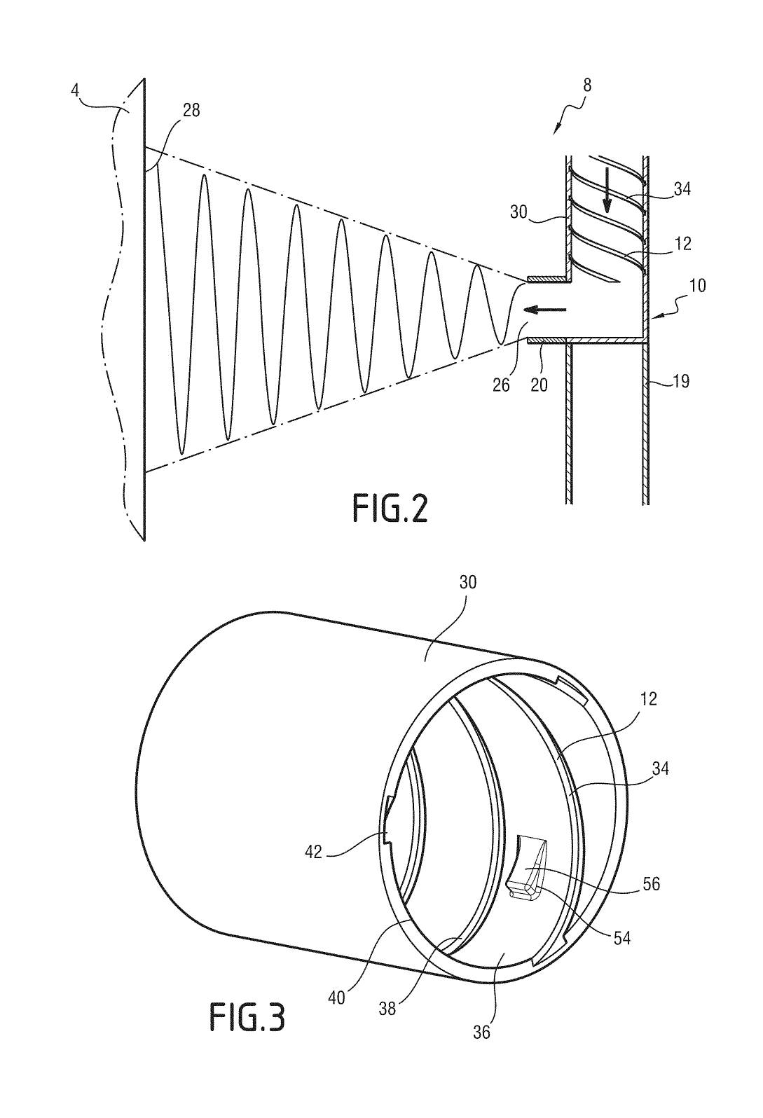

FIG. 2 is a partially sectional schematic view, illustrating a passage pipe able to create a helical rotational movement of the liquid stream around itself according to one embodiment;

FIG. 3 is a perspective view of a segment of the passage pipe, illustrating the means able to create a helical rotational movement;

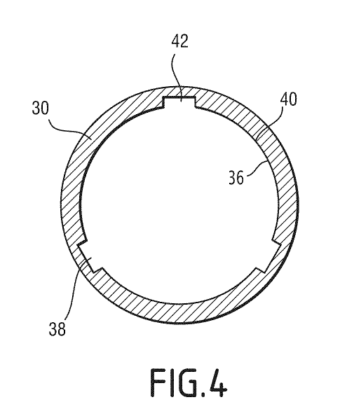

FIG. 4 is a cross-section of the segment of FIG. 3;

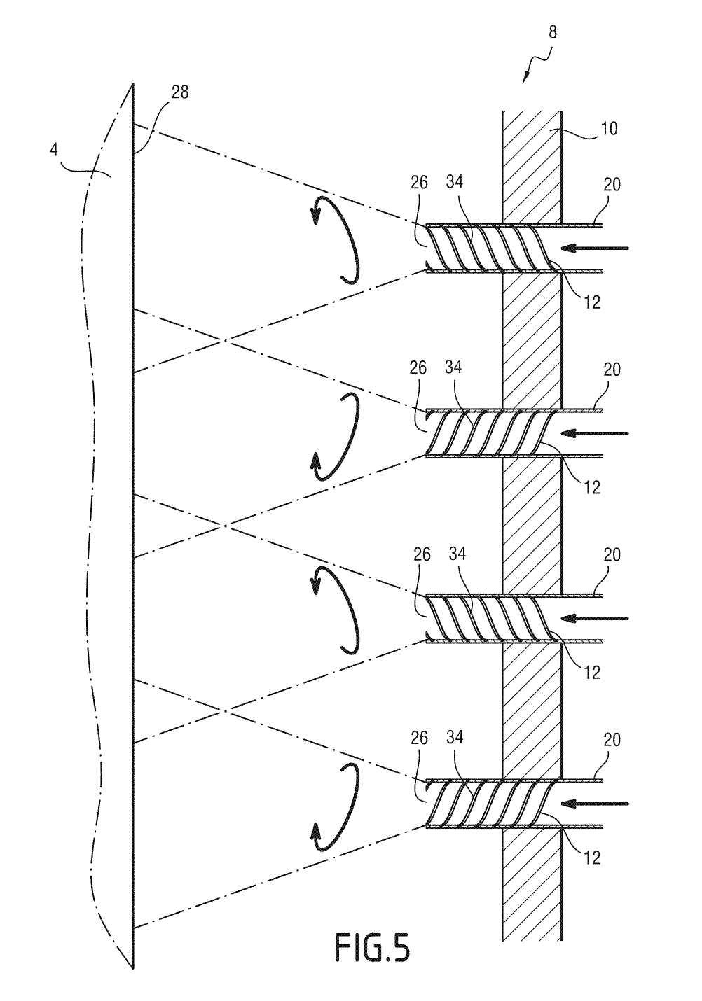

FIG. 5 is a view similar to that of FIG. 2, according to another embodiment;

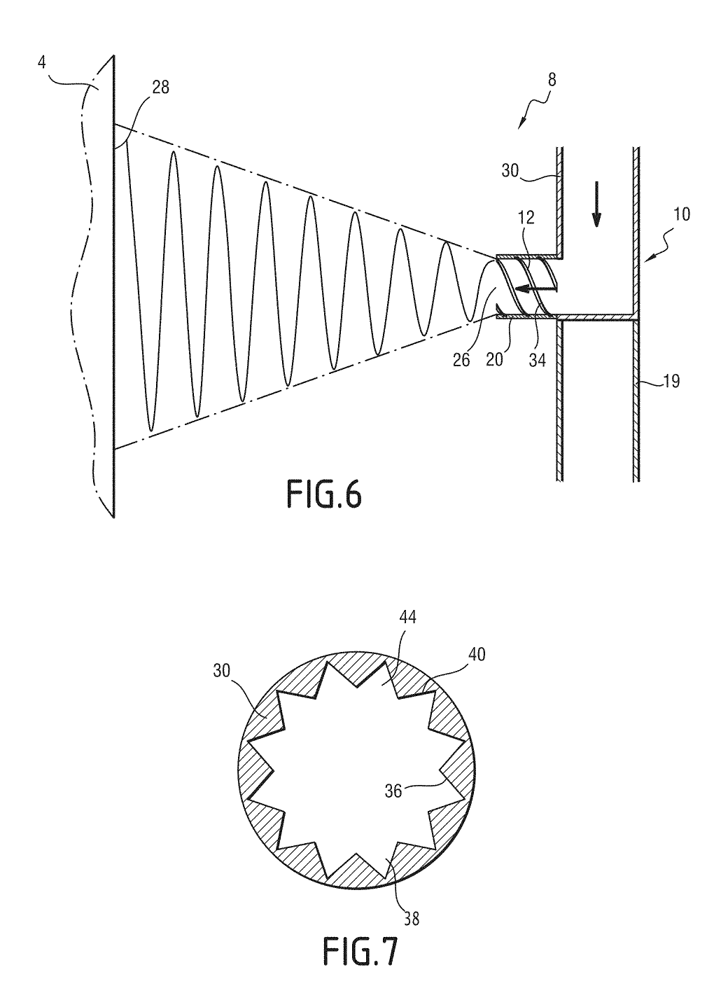

FIG. 6 is a view similar to FIG. 2, illustrating a nozzle able to create a helical rotating movement; and

FIG. 7 is a cross-section of a segment according to another embodiment.

A washing system 2 of a vehicle 4 is illustrated in FIG. 1.

The vehicle 4 is a railway vehicle, such as a train or a tram.

The washing system 2 includes a track 6 on which the vehicle 4 is positioned to be washed. The washing system 2 further comprises washing equipment 8 situated on either side of the track 6 and that includes gantries 10 supporting means 12, illustrated in FIG. 2, able to impart, to the gantries, a helical rotational movement around itself of a washing liquid, and a management system 14 for controlling the washing of the vehicle 4.

In the movement direction of the vehicle 4, the track 6 comprises a track entry 16 and a track exit 18.

Each gantry 10 comprises two vertical posts 19 situated on either side of the track 6. Each post 19 supports one or several nozzles 20 able to spray the washing liquid on the vehicle 4.

Each post 19 is generally tubular. Each post 19 extends vertically over the height of the vehicle 4 to wash the side surfaces of the vehicle 4.

Advantageously, each post 19, or at least one of the posts 19, comprises a central nozzle for washing the side surfaces of the vehicle 4, comprised between a front nozzle pointed toward the front and intended to wash a front surface of the vehicle 4, and a rear nozzle pointed toward the back and intended to wash a rear surface of the vehicle 4. The front and rear nozzles are advantageously oriented specifically to wash the front and rear surfaces of the vehicle 4.

In the example illustrated in FIG. 1, the washing equipment 8 includes several gantries 10, situated longitudinally on either side of the track 6 and alongside it.

The washing equipment 8 in particular includes washing gantries 22 intended to wash the vehicle 4 and rinsing gantries 24 intended to rinse the vehicle 4.

The washing gantries 22 and the rinsing gantries 24 are respectively situated at the track entry 16 and the track exit 18.

The washing gantries 22 are connected to a washing liquid source made up of a mixture of water and cleaning products. The rinsing gantries 24 are connected to a rinse water source.

As illustrated in FIG. 2, the nozzle 20 supported by the post 19 of the gantry 10 comprises an outlet orifice 26 opening outwardly perpendicular to the axis of the post 19 and through which the cleaning liquid is sprayed outward.

The nozzle 20 is placed across from the vehicle 4 such that the outlet orifice 26 is pointed toward a surface 28 of the vehicle 4 to be washed.

As illustrated in FIG. 3, the means 12 able to create a helical rotational movement are situated in a pipe 30 for passage of the cleaning liquid.

The pipe 30 the passage for the washing liquid is situated in the post 19 upstream from the nozzle 20, so as to impart a helical rotational movement to the washing liquid before it is sprayed through the outlet orifice 26.

The means 12 able to create a helical rotational movement include a helical profile 34.

The helical profile 34 is formed on an inner wall 36 of the pipe 30 for passage of the washing liquid.

Advantageously, the helical profile 34 is formed by at least one helical slot 38 formed on the inner wall 36 of the pipe 30 for passage of the washing liquid.

The helical slot 38 is for example made by threading a portion of the pipe 30 for passage of the washing liquid.

Preferably, the helical profile 34 is made by at least three helical slots 38 uniformly distributed over a circumference 40 of the inner wall 36 of the passage pipe 30.

As shown in FIGS. 3 and 4, the helical profile 34 has a rectangular section 42.

The washing liquid is made up of water, a mixture of water and cleaning product, or a specific detergent suitable for vehicle bodies.

Advantageously and as illustrated in FIG. 5, several nozzles 20 are placed longitudinally on a same post 19 and are spaced apart from one another.

The orientations of the helical profiles 34 of each of the nozzles 20 alternate from one nozzle to the next such that the rotation directions of the washing liquid traversing the outlet orifice 26 of each of the nozzles 20 alternate.

The management system 14 as shown in FIG. 1 comprises a detection system 46 of the vehicle 4 that is situated at the track entry 16 and advantageously also before the rinsing gantries 24. It also comprises a control console 48, a decanting system 50 and a water recycling system 52, situated withdrawn from the track 6.

The detection system 46 of the vehicle 4 for example includes position sensors able to detect when the vehicle 4 is in position on the track 6.

The control console 48 activates the automatic implementation of the washing equipment 8 when the detection system 46 detects the presence of the vehicle 4 on the track 6.

The decanting system 50 is situated along the track 6. It is able to recover the cleaning liquid and the rinse water used for the vehicle 4 in order to separate the water and the excess residues mixed with the water.

The water recycling system 52 is connected to the decanting system 50 in order to reuse the water for other wash cycles of the vehicle 4 or to wash other vehicles. It is also designed to recover rainwater in order to supply the washing equipment with water. In this way, the water consumption is reduced, which makes it possible to decrease costs and the environmental impact of the washing equipment 8.

According to one alternative embodiment, the means 12 able to create a helical rotational movement are situated in the nozzle 20, as illustrated in FIG. 6, or both in the nozzle 20 and in the pipe 30 for passage of the washing liquid.

According to one particular embodiment, the washing equipment 8 comprises means for rotating the nozzle 20 suitable for rotating the nozzle 20 around an axis perpendicular to the longitudinal axis of the gantry 10 and off-centered relative to the axis of the nozzle 20. Such a configuration makes it possible to broaden the impact area of the washing liquid leaving the nozzle 20.

According to one alternative embodiment illustrated in FIG. 7, the helical profile 34 is made by more than 3 helical slots 38, for example by 12 helical slots 38, and each helical slot 38 has a triangular section 44.

According to another embodiment, the helical profile 34 is made by one or several helical ribs. The or each rib protrudes on the inner wall 36 of the passage pipe 30.

Advantageously, the means 12 able to create a helical rotational movement include one or several vane(s) 54. One such vane is shown in FIG. 3.

The or each vane 54 is fixed and protrudes on the inner wall 36 of the pipe 30 for passage of the cleaning liquid.

The or each vane 54 comprises a main surface 56 that is generally concave so as to form a ramp for rotating the washing liquid, and two side walls parallel to one another.

Advantageously, the side walls of each vane 54 extend parallel to the direction of the helical slot 38.

A method for washing a vehicle 4 will now be described.

First, the detection system 46 detects a vehicle 4 in position on the track entry 16 of the track 6.

Next, the control console 48 of the washing equipment 8 activates the spraying of the washing liquid through the nozzles 20 of the washing gantries 22. The washing liquid is then made up of a mixture of water and cleaning product, or a specific detergent.

The washing liquid passes through the passage pipe 30 provided with means 12 able to create a helical rotational movement. The washing liquid is then given a helical rotational movement that it will keep until it is sprayed through the outlet orifice 26 of the nozzle 20. When the washing liquid traverses the passage pipe 30 provided with means 12 able to create a helical rotational movement, it is given a helical rotational movement and thus creates a vortex effect.

The expression “vortex effect” corresponds to the name given by Schauberger to the helical rotational movement imparted to a fluid and allowing that fluid to store a large quantity of kinetic energy.

Under the vortex effect, the washing liquid stores a large quantity of kinetic energy that allows it to return a substantial force to the surface 28 of the vehicle 4 to be washed. Any dirtiness present on this surface 28 is therefore easily eliminated.

The vehicle 4 is next moved on the track 6, from the track entry 16 toward the track exit 18.

The control console 48 then activates the spraying of rinse water through the nozzles 20 of the rinsing gantries 24, onto the surface 28 of the vehicle 4 to be rinsed.

The water used in the mixture of water and cleaning product, like that used to rinse the vehicle 4, is conveyed from the water recycling system 52. The dirty water, once used, enters the decanting system 50 to be returned to the water recycling system 52.

According to another embodiment, the washing liquid is conveyed by the passage pipe 30 to the nozzle 20, the latter being provided with means 12 able to create a helical rotational movement. The washing liquid is then given a helical rotational movement just before it is sprayed through the outlet orifice 26 of the nozzle 20.

Optionally, the washing liquid first passes through the passage pipe 30 equipped with means 12 able to create a helical rotational movement, then secondly it passes through the nozzle 20, also equipped with means 12 able to create a helical rotational movement.

Optionally, the washing gantries 22 and the rinsing gantries 24 are combined such that a same gantry 10 performs the washing and rinsing of the vehicle 4. Thus, the vehicle 4 is not placed on the track 6 before the rinsing step.

According to an alternative embodiment, the rinse water comes from an independent pipe that does not include means 12 able to create a helical rotational movement.

The embodiments described above are merely examples. Structural changes may be made without altering the operation of the washing equipment.

The washing equipment described above allows effective washing of the vehicle by vortex effect of the liquid sprayed on the surface to be washed.

The alternating rotation of the liquid streams leaving the nozzle in particular makes it possible to avoid interference between the streams, and therefore cancellation of the rotation speeds.

The maintenance of such washing equipment is inexpensive and easier. Furthermore, such equipment consumes little water and little cleaning product, which decreases its environmental impact.

What is claimed is:

1. Washing equipment for a vehicle, comprising:
at least one gantry defining a track for the vehicle,
at least one nozzle supported by the gantry and intended to spray a cleaning liquid on the vehicle, and
a helical profile configured to create a helical rotational movement of the cleaning liquid relative to the gantry,
wherein the helical profile is suitable for ensuring the rotation of the cleaning liquid around the axis of the stream of cleaning liquid leaving the nozzle.

2. The washing equipment according to claim 1, wherein the helical profile is situated in a pipe for passage of the cleaning liquid.

3. The washing equipment according to claim 1, wherein the helical profile is situated in the nozzle.

4. The washing equipment according to claim 1, wherein the helical profile is situated on an inner wall of a passage pipe for the cleaning liquid.

5. The washing equipment according to claim 4, comprising a plurality of helical profiles distributed over a circumference of the inner wall of the pipe for passage of the cleaning liquid.

6. The washing equipment according to claim 1, wherein the helical profile comprises at least one vane.

7. The washing equipment according to preceding claim 1, wherein the gantry supports several nozzles spaced longitudinally apart from one another.

8. The washing equipment according to claim 7, wherein the helical profile is arranged so that the rotation direction of the cleaning liquid leaving each nozzle alternates between the adjacent nozzles.

9. The washing equipment according to claim 1, further comprising a nozzle rotator configured to rotate the nozzle around an axis perpendicular to the longitudinal axis of the gantry and off-centered relative to the axis of the nozzle.

10. A washing method consisting of setting a cleaning liquid in helical rotation around the axis of the stream of cleaning liquid and spraying it on a vehicle.
